(19) United States
(12) Patent Application Publication
(10) Pub. No.: US 2009/0246523 A1
(43) Pub. Date: Oct. 1, 2009

(54) Small Diameter Calcium Aluminate Based Catalyst Supports by Extrusion and Pelletizing

(76) Inventors: Shizhong Jason Zhao, Louisville, KY (US); David P. Tolle, Louisville, KY (US); Jurgen R. Ladebeck, Louisville, KY (US)

Correspondence Address: Lynn Schwenning, 1600 West Hill Street, Louisville, KY, 40210, US

(21) Appl. No.: 12/057,571

(22) Filed: Mar. 28, 2008

(51) Int. Cl. B32B 5/16; C01F 7/16

(52) U.S. Cl. 428/402; 423/600

(57) ABSTRACT

A calcium-aluminate cement based catalyst support having a cross-sectional diameter as small as 0.5 mm and as large as 1.6 mm wherein said particles are formed by extrusion or pelletizing is disclosed.

### BACKGROUND

The present development is a small diameter calcium-aluminate cement based catalyst support wherein the support has a cross-sectional diameter of from 0.5 mm up to 1.6 mm and is formed by extrusion or pelletizing. The calcium-aluminate supports of the invention are expected to have use in any application that uses a catalyst normally carried on a small-diameter calcium aluminate based support formed via tabletting. Relatively short times, if any, are required for curing the small-diameter calcium-aluminate cement supports, resulting in an improvement in the efficiency of the support manufacturing process.

Calcium-aluminate based catalyst supports are traditionally made by mixing a calcium aluminate cement, alumina and calcium (in the hydroxide or oxide form) with water to form a mixture which is dried, aged, milled/screened, aged again, then mixed with a lubricant such as graphite, formed into desired shape (normally by tabletting), autoclaved (treat with steam) and thermally treated. After the calcium-aluminate tabs are thermally treated, they may be loaded with metal, dried and calcined. The process to make the catalyst support is very long due to the nature of the cement—after the cement is mixed and dried, the cement must also be aged. The entire process can take weeks from start to finish.

Cement is rarely extruded to form a catalyst support because the cement may harden during the mixing and extruding process (process heat can accelerate the hydration of the cement). But pellet size is limited by tabletting because it is extremely difficult to make pellets with a diameter less than 1.5 mm by tabletting. Further making pellets with a diameter less than 3 mm by tabletting is usually not economically efficient for most catalytic applications.

Calcium-aluminate cement has been used in combination with other materials to form, by extrusion, supported catalysts having cross-sectional diameters as small as 1.6 mm. For example, in U.S. Pat. No. 6,261,465, a catalyst is prepared by taking a nickel or cobalt material and dry mixing it with calcium-alumina cement, then the dry feed is mixed with water and formed into extruded pellets of diameter of about 1.6 mm, after which the pellets are dried. U.S. Pat. No. 5,220,110 teaches cement-comprising compositions produced by dry-mixing a Group VIII metal oxide with calcium-aluminate and a small amount of graphite, adding water to form a paste, extruding the paste into particles having a particle diameter as small as 1.6 mm and drying the extrudate. Although these catalysts include calcium-aluminate cement in the compositions, by adding other metals and metal oxides to the calcium-aluminate cement before extrusion, the cement is diluted so the risk of the cement hardening during the extrusion process is reduced. Even then, the smallest cross-sectional diameter for the extrudates is 1.6 mm.

### SUMMARY OF THE PRESENT INVENTION

The present development is a small-diameter calcium-aluminate cement based catalyst support. The support has a cross-sectional diameter as small as 0.5 mm and as large as 1.6 mm and is formed by extrusion or pelletizing.

The small-diameter cement-based support is made by first mixing alumina oxide or hydroxide and calcium oxide or hydroxide, and optionally, low-calcium calcium aluminate cement, with deionized water to form a mixture suitable for extrusion or pelletizing. The mixture is then extruded or pelletized to the desired shape, such as cylinders, hollow cylinders, tri-lobe, and quarter-lobe, among others. The shaped material is then dried to remove excess moisture and is treated at a temperature of from 1100° C. to 1500° C. to form desirable calcium aluminate phases.

### DETAILED DESCRIPTION OF THE INVENTION

The present development is a small-diameter calcium-aluminate cement based catalyst support wherein the support has a cross-sectional diameter of from 0.5 mm up to 1.6 mm and is formed by extrusion or pelletizing. The calcium-aluminate supports formed by the inventive process are expected to have use in any application that uses a catalyst normally carried on a small-diameter cement-based support formed via tabletting, such as catalysts used for steam reforming, for autothermal reforming, or for catalytic partial oxidization.

The small-diameter catalyst support is made by mixing aluminum oxide, aluminum hydroxide or other alumina compounds, calcium oxide, calcium hydroxide, calcium carbonate, or other calcium compounds, and optionally, low-calcium calcium aluminate cement with a sufficient quantity of liquid, such as deionized water, to make a homogeneous paste. The materials are mixed using an Eirich mixer with a mixing speed of 15-35 rpm for the rotor and 15-50 rpm for the pan, or using any device commonly used in the art to ensure that a high viscosity mixture of materials is adequately blended to form a homogeneous paste. The calcium oxide content of the support may range from zero wt % up to about 50 wt %.

The paste is then extruded or pelletized to form shaped pellets having a cross-sectional diameter of from 0.5 mm up to 1.6 mm. The extrudates may be shaped as, without limitation, cylinders, hollow cylinders, tri-lobed structures, quarter-lobed structures, other multi-lobed shapes, or any shape known in the art for catalyst use.

The shaped material is dried to remove excess moisture. Techniques for drying catalyst supports are known in the art. For the inventive process, the recommended drying conditions are to expose the extrudates to circulating dry heated air having a temperature of from 70° C. to 350° C. for from 2 hours to 20 hours or until the extrudates reach a moisture level of less than 5%.

The dried extrudates are then subjected to high heat treatment. Specifically, the extrudates are heated to a temperature of from 1100° C. to 1500° C. for from 2 hours to 36 hours. The material is preferably calcined at as low a temperature and as long a period of time as is possible to promote uniform calcination. As is known in the art, the calcination completion time can be determined for the resulting support when either certain phases, such as CaO.Al₂O₃ and CaO, have been eliminated from the composition or when the BET surface area is within a predetermined range.

The following are representative examples for making the catalyst of the present development. These examples are presented to further explain the invention and are not intended, or to be taken, to limit the scope of the invention.

General Procedure for Examples 1-7: Alumina in the Boehmite form, Ca(OH)₂ (such as Alcoa's C-30, Sasol's Pural SB, Sasol's Pural SCF and UOP's Versal 700), and optionally Methocel, are placed in a plastic bag and manually mixed for about 20 seconds. The mixture is then placed in an Eirich mixer and the materials are dry mixed for about 20 seconds. A predetermined Amount A of DI water and a predetermined Amount B of nitric acid are added to the mixer within about a 60-second period with the rotor and pan running. Mixing is continued for Time A. The paste is extruded using a Bonnot extruder to form extrudates having the dimensions shown in Table 1. The formed extrudates are dried at 177° C. for 2 hours and then 343° C. for 16 hours in a gas fired oven. The dried extrudates of Examples 1-6 are then calcined at 1400° C. for 6 hours in a high temperature oven; the dried extrudates of Example 7 are then calcined at 1150° C. for 6 hours in a high temperature oven. The phase distributions for the extrudates are determined by X-ray diffraction after calcination and are reported in Table 1.

TABLE I

| | Ex 1 | Ex 2 | Ex 3 | Ex 4 |
|---|---|---|---|---|
| Alumina Amount (grams) | 1884 | 1884 | 1507.2 | 1312 |
| Ca(OH)₂ (grams) | 115.1 | 115.1 | 92.1 | 285.8 |
| Calcium Aluminate Cement | 0 | 0 | 0 | 0 |
| (x wt % CaO) | | | | |
| Methocel (grams) | 0 | 0 | 40 | 78 |
| DI water (Amt A - mL) | 1614 | 1718 | 750 | 400 |
| Nitric acid (Amt B - mL) | 18.75 | 18.75 | 15 | 15 |
| Time A (minutes) | 10 | 10 | 10 | 5 |
| Phase (% A/% CA6/% CA2/ | 30/70/0/ | 37/63/0/ | 52/40/8/ | 37/5/39/ |
| % CA/% C12O7/% C) | 0/0/0 | 0/0/0 | 0/0/0 | 19/0/0 |
| Calcined Extrudate | | | | |
| Diameter (mm) | 1.8 | 1.8 | 1.0 | 1.4 |
| Shape^{A} | CDS | CDS | CDS | CDS |
| Avg side crush strength | >27 | 16 | 8.0 | 1.0 |
| Pore Volume (mL/g) | 0.22 | 0.35 | 0.29 | 0.42 |
| BET surface area (m²/g) | 2.6 | 3.0 | 2.4 | 1.7 |
| wt % CaO | 5.8 | 5.8 | 5.8 | 18 |

| | Ex 5 | Ex 6 | Ex 7 |
|---|---|---|---|
| Alumina Type/Amount (grams) | 2110 | 2112 | 1066.7 |
| Ca(OH)₂ (grams) | 0 | 21.6 | 1081.1 |
| Calcium Aluminate Cement | 817.4 (17%) | 0 | 0 |
| (x wt % CaO) | | | |
| Methocel (grams) | 0 | 0 | 0 |
| DI water (Amt A - mL) | 2500 | 1350 | 1350 |
| Nitric acid (Amt B - mL) | 90 | 48 | 48 |
| Time A (minutes) | 15 | 8 | 5 |
| Phase (% A/% CA6/% CA2/ | 41/57/2/ | 72/28/0/ | 0/0/9/ |
| % CA/% C12O7/% C) | 0/0/0 | 0/0/0 | 26/40/25 |
| Calcined Extrudate | | | |
| Diameter (mm) | 0.95 | 1.09 | 1.43 |
| Shape | CDS | CDS | CDS |
| Avg side crush strength | >43 | 7.0 | 2.8 |
| Pore Volume (mL/g) | 0.17 | 0.37 | 0.44 |
| BET surface area (m²/g) | 2.8 | 5.7 | 4.2 |
| wt % CaO | 8.1 | 1.0 | 50 |

^{A}“CDS” refers to a tri-lobed extrudate available from Sud-Chemie.

It is understood that one skilled in the art may make alterations to the embodiments shown and described herein without departing from the scope of the invention. For example, it is anticipated that although details are provided herein for extrudates, the same conditions may be applied for the preparation of pellets. Also, it is anticipated that the particular shape of the support may extend beyond those specifically listed herein, but as long as the shape has been produced by extrusion or pelletizing and has a cross-sectional diameter of less than 1.6 mm, the resulting catalyst support falls within the scope of the claims of the present invention.

What is claimed is:

1. A calcium-aluminate cement-based catalyst support having a cross-sectional diameter of from 0.5 mm up to 1.6 mm wherein said support is formed by extrusion or pelletizing.

2. The support of claim 1 wherein said support consists essentially of calcium-aluminate cement.

3. The support of claim 1 wherein said support comprises calcium oxide at a concentration of from zero wt % up to about 50 wt %.

4. A small-diameter calcium-aluminate cement based catalyst support made by the steps:
a) combining an aluminum source, a calcium source, and a liquid;
b) mixing said aluminum source, said calcium source and said liquid under conditions to form a homogeneous paste;
c) forming shaped pellets from said paste by extrusion or pelletizing wherein said pellets have a cross-sectional diameter of from 0.5 mm up to 1.6 mm;
d) drying said shaped pellets until the pellets reach a moisture level of less than 5%; and,
e) calcining said pellets at a temperature of from 1100° C. to 1500° C. for from 2 hours to 36 hours to form said catalyst support.

5. The method of claim 4 wherein the aluminum source is selected from the group consisting of aluminum oxide, aluminum hydroxide, a low-calcium calcium aluminate cement and combinations thereof.

6. The method of claim 4 wherein the calcium source is selected from the group consisting of calcium oxide, calcium hydroxide, calcium carbonate, a low-calcium calcium aluminate cement and combinations thereof.

7. The method of claim 6 wherein said calcium source is added at a concentration to form a pellet having a calcium oxide content from zero wt % up to about 50 wt %, and wherein the balance of the pellet consists essentially of aluminum oxide.

8. The method of claim 4 wherein said liquid is water.

9. The method of claim 4 wherein said mixing is accomplished by using a mixer having a rotor mixing speed of from 15 rpm to 35 rpm and a pan mixing speed of from 15 rpm to 50 rpm.

10. The method of claim 4 wherein said pellets are in the form of cylinders, hollow cylinders, tri-lobed structures, or quarter-lobed structures.

11. The method of claim 4 wherein said pellets are dried by exposing the pellets to circulating dry heated air having a temperature of from 70° C. to 350° C. for from 2 hours to 20 hours.
